(19) United States
(12) Patent Application Publication
(10) Pub. No.: US 2026/0222273 A1
(43) Pub. Date: Jul. 30, 2026

(54) COMMUNICATION CONTROL APPARATUS, COMMUNICATION CONTROL PROCESSING METHOD, AND NON-TRANSITORY COMPUTER READABLE MEDIUM

(71) Applicant: NEC Corporation, Tokyo (JP)

(72) Inventors: Iori TOKUDA, Tokyo (JP); Hiroki ITSUKAICHI, Tokyo (JP); Yoshihiro MISHIMA, Tokyo (JP)

(73) Assignee: NEC Corporation, Tokyo (JP)

(21) Appl. No.: 19/159,049

(22) PCT Filed: Feb. 28, 2023
(86) PCT No.: PCT/JP2023/007361

§ 371 Date: Aug. 22, 2025

(51) Int. Cl. H04L 41/06; G07C 5/10

(52) U.S. Cl. CPC H04L 41/06; G07C 5/10

(57) ABSTRACT

A communication control device (103) comprises: a detection unit (132); a calculation unit (133); and a communication maintenance unit (134). The detection unit (132) detects an abnormality in communication on the basis of a plurality of detection items. The calculation unit (133) calculates an abnormality value when an abnormality is detected. The communication maintenance unit (134) performs processing for continuing the communication when the abnormality value exceeds a predetermined abnormality threshold value.

### TECHNICAL FIELD

The present invention relates to a communication control device, an information processing system, a communication control processing method, and a recording medium.

### BACKGROUND ART

PTL 1 discloses a technique for detecting a communication abnormality between a data communication device and devices to be remotely managed (image forming devices) in a remote management system.

When a communication abnormality occurs with any of the image forming devices, the data communication device described in PTL 1 detects the communication abnormality. Then, the data communication device counts the number of occurrences of the detected communication abnormality for each type, and stores the counted number of occurrences of the communication abnormality for each type in the nonvolatile RAM together with the IDs unique to the image forming devices of the communication partners as communication abnormality information.

In addition, the data communication device described in PTL 1 transmits communication abnormality information in the nonvolatile RAM to the central control device periodically or in response to a request from the central control device. In addition, when any of the number of occurrences of the individual communication abnormality, which is in the communication abnormality information in the nonvolatile RAM, reaches a predetermined number, the data communication device transmits the communication abnormality information including the number of occurrences of the communication abnormality to the central control device.

### CITATION LIST

### Patent Literature

PTL 1: JP 2001-306427 A

### SUMMARY OF INVENTION

### Technical Problem

In the technique described in PTL 1, when a communication abnormality between the data communication device and an image forming device is detected, the data communication device transmits communication abnormality information to the central control device. As a result, the user of the central control device may be able to know the communication abnormality between the data communication device and the image forming device. However, in order to solve the communication abnormality, it is necessary for the user of the central control device to cope with the communication abnormality, and it is difficult to autonomously sustain the communication between the data communication device and the image forming device.

In view of the above-described problems, an example of an object of the present invention is to provide a communication control device, an information processing system, a communication control processing method, a recording medium, and the like that achieves autonomously sustaining communication.

### Solution to Problem

According to an aspect of the present invention, there is provided
a communication control device including:
detection means for detecting an abnormality in communication based on a plurality of detection items;
calculation means for calculating an abnormality value when an abnormality is detected; and
communication maintenance means for performing a process for continuing the communication when the abnormality value exceeds a predetermined abnormality threshold value.

According to an aspect of the present invention, there is provided
an information processing system including:
a server device;
an information processing device that communicates with the server device and executes main processing; and
a communication control device that controls communication between the server device and the information processing device,
the communication control device includes:
detection means for detecting an abnormality in communication based on a plurality of detection items;
calculation means for calculating an abnormality value when an abnormality is detected; and
communication maintenance means for performing a process for continuing the communication when the abnormality value exceeds a predetermined abnormality threshold value.

According to an aspect of the present invention, there is provided
a communication control processing method, including
causing one or more computers to:
detect an abnormality in communication based on a plurality of detection items;
calculate an abnormality value when an abnormality is detected; and
perform a process for continuing the communication when the abnormality value exceeds a predetermined abnormality threshold value.

According to an aspect of the present invention, there is provided
a recording medium including a program recorded thereon, the program being configured to cause one or more computers to execute:
detecting an abnormality in communication based on a plurality of detection items;
calculating an abnormality value when an abnormality is detected; and
performing a process for continuing the communication when the abnormality value exceeds a predetermined abnormality threshold value.

### Advantageous Effects of Invention

According to an aspect of the present invention, communication can be autonomously sustained.

### BRIEF DESCRIPTION OF DRAWINGS

FIG. 1 is a diagram illustrating an outline of a communication control device according to a first example embodiment.

FIG. 2 is a flowchart illustrating an outline of communication control processing according to the example embodiment.

FIG. 3 is a diagram illustrating a configuration example of an information processing system according to the first example embodiment.

FIG. 4 is a diagram illustrating an example of setting information according to the first example embodiment.

FIG. 5 is a diagram illustrating a hardware configuration example of a server device according to the first example embodiment.

FIG. 6 is a diagram illustrating a hardware configuration example of an information processing device and a communication control device according to the first example embodiment.

FIG. 7 is a flowchart illustrating an example of information processing according to the first example embodiment.

FIG. 8 is a flowchart illustrating an example of communication control processing according to the first example embodiment.

FIG. 9 is a flowchart illustrating an example of the communication control processing according to the first example embodiment.

FIG. 10 is a flowchart illustrating an example of operation confirmation process according to the first example embodiment.

FIG. 11 is a flowchart illustrating an example of a GIP confirmation process according to the first example embodiment.

FIG. 12 is a flowchart illustrating an example of a reception confirmation process according to the first example embodiment.

FIG. 13 is a flowchart illustrating an example of a HD confirmation process according to the first example embodiment.

FIG. 14 is a diagram illustrating a configuration example of an information processing system according to a first modification.

FIG. 15 is a diagram illustrating a configuration example of an information processing system according to a second example embodiment.

FIG. 16 is a flowchart illustrating an example of change processing according to the second example embodiment.

### EXAMPLE EMBODIMENTS

Hereinafter, example embodiments of the present invention will be described with reference to the drawings. In all the drawings, the same components are denoted by the same reference numerals and characters, and the description thereof will be omitted as appropriate.

### First Example Embodiment

### (Outline)

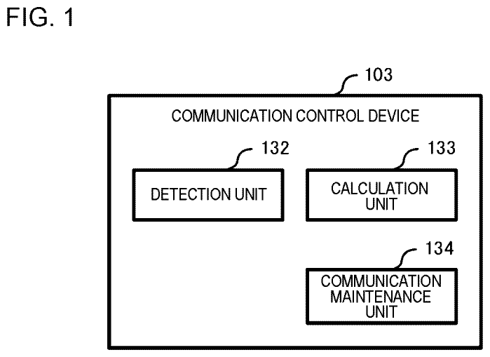

FIG. 1 is a diagram illustrating an outline of a communication control device 103 according to a first example embodiment. The communication control device 103 includes a detection unit 132, a calculation unit 133, and a communication maintenance unit 134.

The detection unit 132 detects an abnormality in communication based on a plurality of detection items. The calculation unit 133 calculates an abnormality value when an abnormality is detected. The communication maintenance unit 134 performs a process for continuing the communication when the abnormality value exceeds a predetermined abnormality threshold value.

According to the communication control device 103, communication can be autonomously sustained.

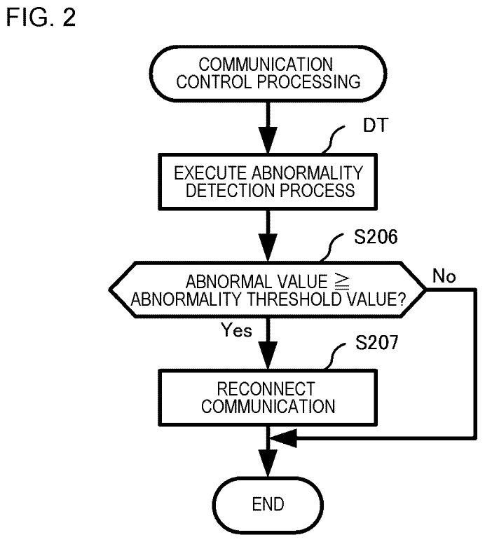

FIG. 2 is a flowchart illustrating an outline of communication control processing according to the example embodiment.

One or more computers detect an abnormality in communication based on a plurality of detection items, and calculate an abnormality value when the abnormality is detected (abnormality detection process DT). When the abnormality value exceeds a predetermined abnormality threshold value (step S206; Yes), one or more computers perform a process for continuing communication (step S207).

According to this communication control processing, communication can be autonomously sustained.

Hereinafter, a detailed example of the first example embodiment will be described.

### (Details)

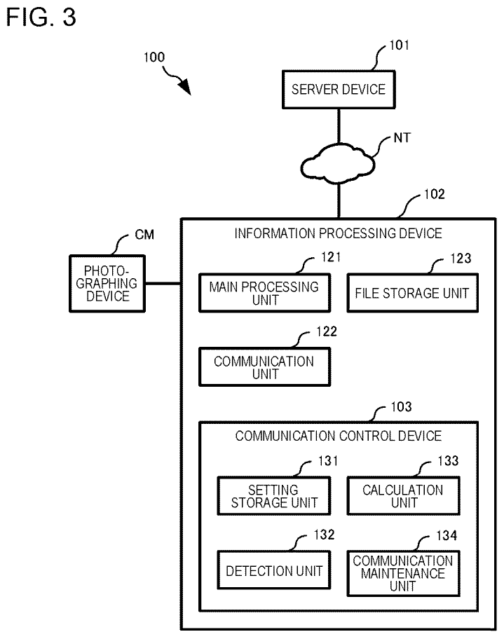

FIG. 3 is a diagram illustrating a configuration example of an information processing system 100 according to the first example embodiment. The information processing system 100 is a system that performs a process for continuing communication when an abnormality in communication is detected.

The information processing system 100 includes a server device 101, an information processing device 102, and a communication control device 103.

The server device 101 and the information processing device 102 are typically provided at a remote location and are connected to each other via the network NT. The network NT is a communication network configured in a wired manner, a wireless manner, or a combination thereof. As a result, the server device 101 and the information processing device 102 can communicate with each other via the network NT to transmit and receive information to and from each other.

The information processing device 102 and the communication control device 103 are typically provided close to each other. In the present example embodiment, the information processing device 102 includes a communication control device 103 therein. The communication control device 103 is connected to the main processing unit 121 via, for example, a line (for example, wiring or the like) inside the information processing device 102 so as to be able to transmit and receive information to and from each other.

Note that the communication control device 103 may be provided outside the information processing device 102. Also in this case, the information processing device 102 and the communication control device 103 may be connected to each other so as to be able to transmit and receive information to and from each other via the line LN. The line LN may be a wired line capable of stably transmitting and receiving information, but may be a wireless line or a line configured by combining wired and wireless.

In the present example embodiment, an example will be described in which the information processing device 102 is a device mounted on a moving body. The moving body is, for example, an automobile.

The information processing device 102 according to the present example embodiment performs processing for automatic driving by using, for example, an instruction from a user, information acquired from a photographing device CM (for example, a camera) that photographs the outside of the vehicle, and the like. In this processing, the information processing device 102 transmits and receives information to and from the server device 101 as appropriate.

Note that the photographing device CM is an example of a sensor for the information processing device 102 to acquire information from the outside, and the sensor is not limited to the photographing device CM. Furthermore, the information processing system 100 is not limited thereto, and may be applied to a system in which the server device 101 and the information processing device 102 communicate with each other to execute various types of processing. Furthermore, the number of information processing devices 102 may be more than one.

### (Functional Configuration Example of Server Device 101 According to First Example Embodiment)

The server device 101 functionally communicates with, for example, the information processing device 102 to execute server processing.

The server processing according to the present example embodiment includes, for example, processing of acquiring video information based on a video captured by the photographing device CM from the information processing device 102 and storing the video information. Furthermore, for example, the server processing may include processing of generating a vehicle control instruction for automatic driving based on the video information and transmitting the vehicle control instruction to the information processing device 102. Note that the server processing is not limited thereto.

### (Functional Configuration Example of Information Processing Device 102 According to First Example Embodiment)

The information processing device 102 communicates with the server device 101 to execute main processing. The information processing device 102 functionally includes, for example, a main processing unit 121, a communication unit 122, and a file storage unit 123.

The main processing unit 121 executes main processing. The main processing according to the present example embodiment includes, for example, one or more processing such as compression processing of compressing a video captured by the photographing device CM to generate video information. Note that the main processing is not limited to the compression processing, and may include video analysis processing such as detecting an object around the automobile from a video, for example.

The communication unit 122 communicates with the server device 101. For example, the communication unit 122 executes transmission processing and reception processing.

The transmission processing is processing of transmitting transmission information to the server device 101. The transmission information includes, for example, a result of the main processing. The result of the main processing according to the present example embodiment includes, for example, video information.

The reception processing is processing of receiving reception information from the server device 101. The reception information according to the present example embodiment may include, for example, the above-described vehicle control instruction. In addition, for example, the reception information may include a response to be used in general communication such as ACK.

Note that the information transmitted and received by the communication unit 122 through communication with the server device 101 is not limited to the above-described example.

The file storage unit 123 stores various types of information. In the present example embodiment, the communication control device 103 also refers to the file storage unit 123.

### (Functional Configuration Example of Communication Control Device 103 According to First Example Embodiment)

The communication control device 103 controls communication between the server device 101 and the information processing device 102. Specifically, when an abnormality in communication is detected, the communication control device 103 performs a process for continuing the communication.

The communication control device 103 functionally includes, for example, a setting storage unit 131, a detection unit 132, a calculation unit 133, and a communication maintenance unit 134.

The setting storage unit 131 is a storage unit for storing the setting information 131a. The setting information 131a includes a plurality of detection items and a plurality of item-specific abnormality values. The plurality of item-specific abnormality values are values each associated with a corresponding one of the plurality of detection items. The plurality of detection items and the item-specific abnormality values may be set in advance.

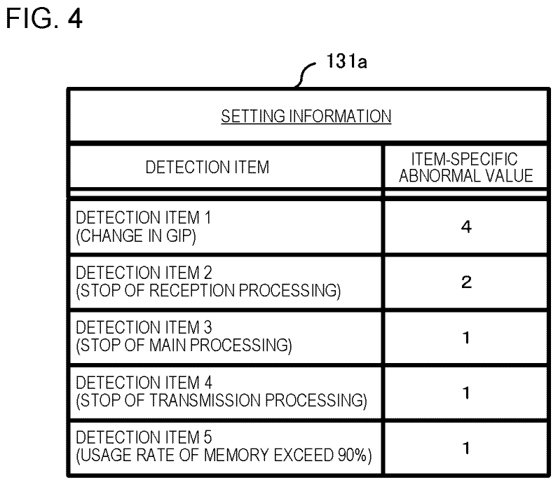

FIG. 4 is a diagram illustrating an example of the setting information 131a according to the first example embodiment. The setting information 131a includes detection items 1 to 5 and item-specific abnormality values associated with each detection item.

The types of the detection items 1 to 5 include (1) an item related to connection of the communication, (2) an item related to reception of information in the communication, (3) an item related to transmission of information in the communication, (4) an item related to main processing, and (5) an item related to hardware that executes the main processing.

Detection item 1 is an example of (1) an item related to communication connection. Here, “communication” is communication between the server device 101 and the information processing device 102, and the same applies to the following. The item related to the communication connection may include an item related to a global internet protocol (GIP) address such as detection item 1.

Detection item 2 is an example of (2) an item related to reception of information in communication.

Detection item 3 is an example of (3) an item related to transmission of information in communication.

The detection item 4 is an example of (4) an item related to main processing.

The detection item 5 is an example of (5) an item related to hardware that executes the main processing. The item related to the hardware that executes the main processing may include an item related to the usage rate of the memory such as the detection item 5. The usage rate is, for example, a ratio of the capacity of the memory actually used to the total capacity of the memory.

The item-specific abnormality values may be appropriately set, and may be each set to, for example, a scale depending on the possibility that the type of the associated detection item causes a communication failure. In the setting information 131a, the detection item 1 of the type (1), which is an item related to communication connection, is associated with a greater value (item-specific abnormality value) than the detection items 2 to 4 of the other types.

Note that the detection items and the types of the detection items are not limited to the above-described examples.

For example, the type of the detection item may include an item related to a period in which a process for continuing communication is performed. The item related to the period may include, for example, a period in which the vehicle stands by in the parking lot and no person sits on the rear seat. In a case in which the automobile is a taxi, the period in which no person rides on the rear seat corresponds to a period in which no passenger rides on the taxi.

For example, the item related to the hardware that executes the main processing may include an item related to at least one of a usage amount of the memory, a usage rate of the memory, a temperature of the hardware, a processing load of the hardware, and a continuous operation time of the hardware.

The item related to the usage amount of the memory is, for example, that the usage amount of the memory exceeds a predetermined amount. The item related to the temperature of the hardware is, for example, that a temperature measured by a temperature sensor (not illustrated) placed in the vicinity of the processor exceeds a predetermined temperature. The item related to the processing load of the hardware is, for example, that the load of the processor exceeds a predetermined ratio with respect to the maximum processing amount. The item related to the continuous operation time of the hardware is, for example, that the processor is continuously operated for more than a predetermined time.

Reference is made again to FIG. 3.

The detection unit 132 detects an abnormality in communication based on a plurality of detection items.

For example, when an abnormality corresponding to one of a plurality of detection items included in the setting information 131a has occurred in communication, the detection unit 132 detects the abnormality.

The calculation unit 133 calculates an abnormality value when an abnormality is detected. For example, when an abnormality is detected, the calculation unit 133 uses the setting information 131a including values (item-specific abnormality values) each associated with a corresponding one of the plurality of detection items, and thereby adds the value (item-specific abnormality value), which is associated with a detection item in which the abnormality is detected, to the abnormality value.

Specifically, for example, when the detection unit 132 detects an abnormality corresponding to any of the plurality of detection items included in the setting information 131a, the calculation unit 133 determines a detection item corresponding to the detected abnormality. Then, the calculation unit 133 determines the item-specific abnormality value associated with the determined detection item in accordance with the setting information 131a. The calculation unit 133 adds the item-specific abnormality value to the abnormality value.

As can be seen from this processing, the abnormality value is a counter for obtaining the total of the item-specific abnormality values.

The communication maintenance unit 134 performs a process for continuing communication between the server device 101 and the information processing device 102 in accordance with a comparison result between the abnormality value and a predetermined abnormality threshold value.

### (Hardware Configuration Example of Information Processing System 100 According to First Example Embodiment)

The information processing system 100 includes a server device 101 and an information processing device 102 including a communication control device 103, which are physically connected via the network NT. The server device 101 and the information processing device 102 are physically different devices. The server device 101 and the information processing device 102 are each composed of, for example, a single device.

(Hardware Configuration Example of Server Device 101 According to First Example Embodiment)

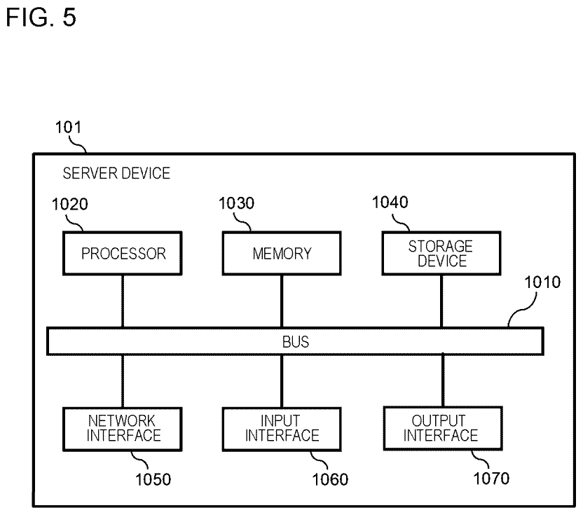

FIG. 5 is a diagram illustrating a hardware configuration example of the server device 101 according to the first example embodiment. The server device 101 physically includes, for example, a bus 1010, a processor 1020, a memory 1030, a storage device 1040, a network interface 1050, an input interface 1060, and an output interface 1070.

The bus 1010 is an example of wiring that forms a data transmission path for the processor 1020, the memory 1030, the storage device 1040, the network interface 1050, the input interface 1060, and the output interface 1070 to transmit and receive data to and from each other. However, the method of connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores a program module for implementing the function of the server device 101 including the storage device 1040. The processor 1020 reads and executes the program module in the memory 1030, thereby implementing the functions related to the program modules. Note that the number of the storage devices 1040 may be more than one.

The network interface 1050 is an interface for connecting the server device 101, which includes the network interface 1050, to the network NT.

The input interface 1060 is an interface for the user to input information. The input interface 1060 includes, for example, a touch panel, a keyboard, a mouse, and the like.

The output interface 1070 is an interface for presenting information to the user. The output interface 1070 includes, for example, a liquid crystal panel, an organic electro-luminescence (EL) panel, or the like.

Note that the server device 101 may physically include a plurality of devices. Each of the devices in this case may be physically have, for example, the configuration illustrated in FIG. 5.

### (Hardware Configuration Example of Information Processing Device 102 and Communication Control Device 103 According to First Example Embodiment)

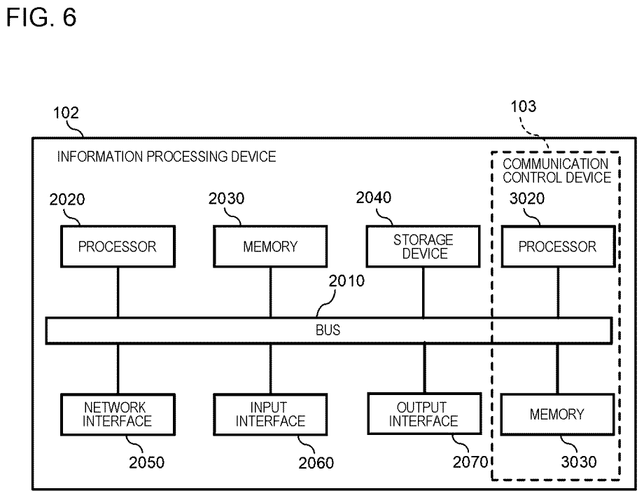

FIG. 6 is a diagram illustrating a hardware configuration example of the information processing device 102 and the communication control device 103 according to the first example embodiment.

The information processing device 102 physically includes, for example, a bus 2010, a processor 2020, a memory 2030, a storage device 2040, a network interface 2050, an input interface 2060, and an output interface 2070.

The information processing device 102 physically includes, for example, a processor 3020 and a memory 3030 for implementing the communication control device 103.

These elements 2010, 2020, 2030, 2040, 2050, 2060 and 2070 may be respectively similar to the elements 1010, 1020, 1030, 1040, 1050, 1060 and 1070 described above. The elements 3020 and 3030 may be respectively similar to the elements 1020 and 1030 described above.

However, the processor 3020 and the memory 3030 are also connected to the bus 2010. The storage device 2040 stores a program module for implementing the functions of the information processing device 102 and the communication control device 103. The number of the storage devices 2040 may be more than one. In addition, the network interface 2050 is an interface for connecting the information processing device 102, which includes the network interface 2050, to the network NT.

Note that the information processing device 102 may physically include a plurality of devices. Examples, in which the information processing device 102 includes a plurality of devices, include an example in which the information processing device 102 including the main processing unit 121 is a physically different device from the communication control device 103. In this case, each of the information processing device 102 and the communication control device 103 may be physically configured similarly to the server device 101 according to the first example embodiment (see FIG. 5).

The configuration example of the information processing system 100 according to the first example embodiment has been described above. From here, an operation example of the information processing system 100 according to the first example embodiment will be described.

### (Operation Example of Information Processing System 100 According to First Example Embodiment)

The information processing system 100 executes information processing executed by the information processing device 102 and communication control processing executed by the communication control device 103. Examples of processing will be each described with

### (Example of Information Processing According to First Example Embodiment)

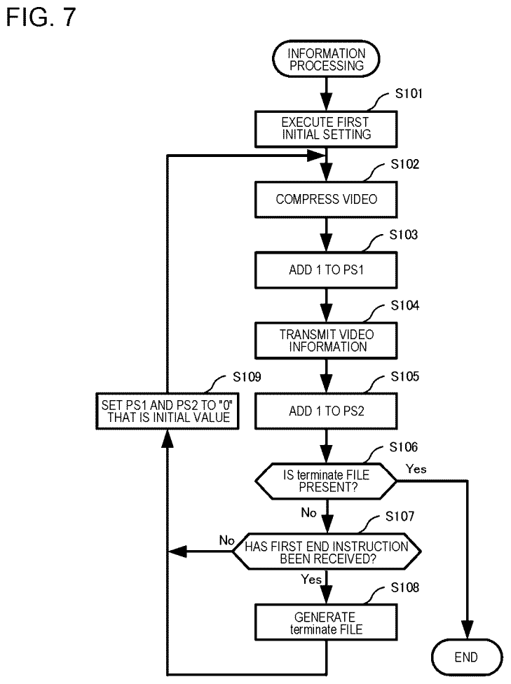

FIG. 7 is a flowchart illustrating an example of information processing according to the first example embodiment. The information processing includes main processing. Hereinafter, with reference to FIG. 7, an example is described in which the main processing is compression processing generated by a video captured by the photographing device CM.

The information processing may be started in response to, for example, an instruction from a user of the information processing device 102, start of a drive source of an automobile, or the like. Note that the trigger for starting the information processing is not limited thereto.

The main processing unit 121 executes first initial setting (step S101).

The first initial setting may include, for example, a processing of establishing communication with the server device 101 via the communication unit 122. At this time, for example, the main processing unit 121 or the communication unit 122 may inquire of the server device 101 and acquire and hold the GIP to be used for communication, or may hold the GIP in advance.

The first initial setting may include, for example, processing of setting each of process counters PSC1 and PSC2 to “0” that is the initial value. PSC1 is a counter for calculating the number of processes executed in the compression processing, which is the main processing. The PSC2 is a counter for calculating the number of processes executed in transmission processing for transmitting video information, which is a result of the main processing, to the server device 101.

The first initial setting may include, for example, processing of deleting the terminate file when the terminate file is stored in the setting storage unit 131. The terminate file is a file to be used to control the end of information processing. In the present example embodiment, as will be described later, the terminate file is also used to control the end of the communication control processing.

Note that the first initial setting is not limited thereto.

The main processing unit 121 acquires the video captured by the photographing device CM and compresses the acquired video (step S102). As a result, the main processing unit 121 generates video information including the compressed video.

The main processing unit 121 adds “1” to PSC1 (step S103).

Note that, the number to be added to PSC1 is not limited to “1”, and, for example, there may be added a number of a predetermined processes executed in step S102.

The communication unit 122 transmits the video information generated in step S102 to the server device 101 (step S104).

The communication unit 122 adds “1” to PSC2 (step S105).

Note that the number to be added to PSC2 is not limited to “1”, and for example, there may be added a number of predetermined processes executed in step S104.

The main processing unit 121 refers to, for example, the file storage unit 123 and determines whether a terminate file is present (step S106).

If the terminate file is present (step S106; Yes), the main processing unit 121 ends the information processing.

When the terminate file is not present (step S106; No), the main processing unit 121 determines whether it has received a first end instruction (step S107).

The first end instruction is an instruction to end the information processing. The first end instruction is, for example, an instruction to stop the drive source of the automobile. Note that the first end instruction is not limited thereto, and may be, for example, a specific instruction from the user.

If the main processing unit 121 has received the first end instruction (step S107; Yes), the main processing unit 121 generates the terminate file (step S108). At this time, the main processing unit 121 may store the terminate file in the file storage unit 123.

If the main processing unit 121 has not received the first end instruction (step S107; No), or after step S108, the main processing unit 121 sets each of the process counters PSC1 and PSC2 to an initial value “0” (step S109). Then, the main processing unit 121 executes the processes from step S102 again.

In the information processing, PSC1 is added when the compression processing, which is the main processing, has been executed. Referring to such PSC1 makes it possible to confirm whether the compression processing, which is the main processing, is continuously executed. In addition, when the transmission processing is executed, PSC2 is incremented. Referring to such PSC2 makes it possible to confirm whether the transmission processing is continuously executed.

Note that the information processing does not necessarily include step S109. In this case, confirming that the value of PSC1 is greater than the previous value makes it possible to confirm whether the compression processing, which is the main processing, is continuously executed. Similarly, confirming that the value of PSC2 is greater than the previous value makes it possible to confirm whether the transmission processing is continuously executed.

### (Example of Communication Control Processing According to First Example Embodiment)

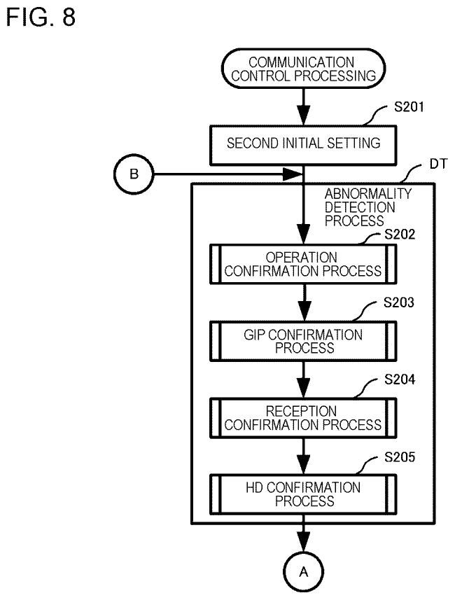

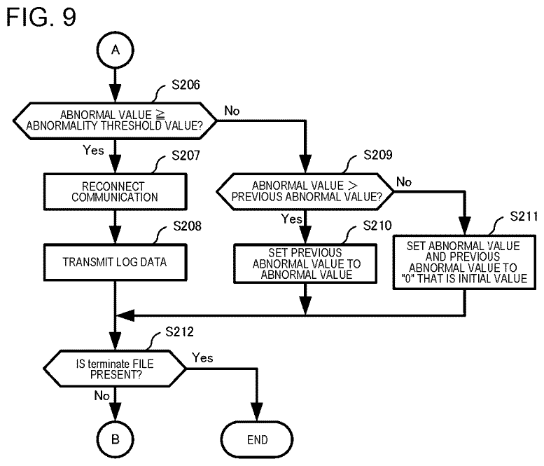

FIGS. 8 and 9 are flowcharts illustrating an example of the communication control processing according to the first example embodiment. The communication control processing includes a process for continuing communication when an abnormality in communication is detected.

Hereinafter, a detailed example for detecting an abnormality in communication using the setting information 131a (see FIG. 4) will be described with reference to FIG. 8.

The communication control processing is started, for example, after the start of information processing. Specifically, for example, immediately after the start of information processing, it may take time to start application software to be used for the information processing. For this reason, the communication control processing may be started after a predetermined standby time (for example, 100 seconds) elapses from the start of the information processing.

The communication control processing may be executed concurrently with the information processing.

The detection unit 132, the calculation unit 133, and the communication maintenance unit 134 execute the second initial setting (step S201).

The second initial setting may include, for example, processing in which the calculation unit 133 sets each of the abnormality value and the previous abnormality value to “0”, which is an initial value. As described above, the abnormality value is a counter for obtaining the total of the item-specific abnormality values. The previous abnormality value is a counter for holding the abnormality value obtained in the previous process in the repeated abnormality detection process DT for detecting an abnormality value to be described later.

The second initial setting may include, for example, a process in which the communication maintenance unit 134 initializes the log data. The log data is data including a record of a process for continuing communication, and is notified to the server device 101. For example, in the initialization of the log data, the communication maintenance unit 134 may store a file having empty contents in the setting storage unit 131 as log data.

The second initial setting may include, for example, a process in which the detection unit 132 deletes the terminate file when the terminate file is stored in the setting storage unit 131.

The second initial setting is not limited thereto.

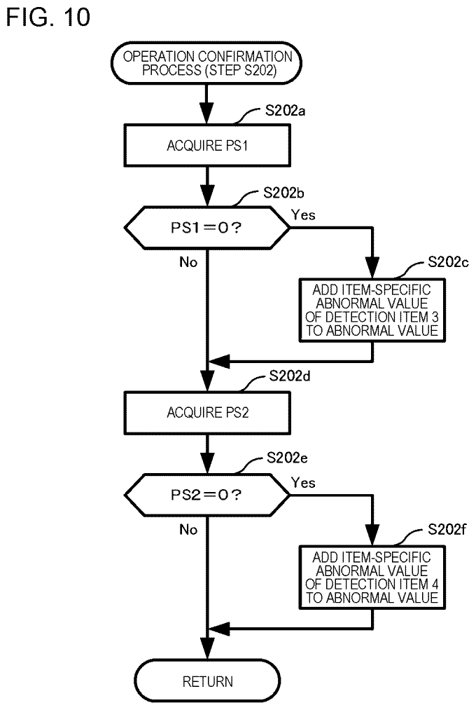

The detection unit 132 and the calculation unit 133 execute a process for obtaining an abnormality value (abnormality detection process DT). The abnormality detection process DT includes processes of steps S202 to S205. Each process of steps S202 to S205 will be described with reference to FIG. 10 to 13.

### (Operation Confirmation Process: Step S202)

FIG. 10 is a flowchart illustrating an example of an operation confirmation process (step S202) according to the first example embodiment.

The detection unit 132 acquires PS1 from, for example, the main processing unit 121 (step S202a).

In order to detect the abnormality corresponding to detection item 3, detection unit 132 determines whether PS1 acquired in step S202a is equal to 0 (step S202b). Note that the method of detecting the abnormality corresponding to the detection item 3 may be appropriately changed.

If it is determined that PS1 is equal to 0 (step S202b; Yes), the calculation unit 133 adds the item-specific abnormality value of the detection item 3 to the abnormality value (step S202c).

Specifically, for example, the calculation unit 133 determines that the detected abnormality corresponds to the detection item 3 in accordance with the setting information 131a and the determination result in step S202b. The calculation unit 133 specifies the item-specific abnormality value “1” associated with the detection item 3 in the setting information 131a. The calculation unit 133 adds the item-specific abnormality value “1” to the abnormality value.

If it is determined that PS1 is not 0 (step S202b; No), or after step S202c, the detection unit 132 acquires PS2 from, for example, the main processing unit 121 (step S202d).

In order to detect the abnormality corresponding to detection item 4, detection unit 132 determines whether PS2 acquired in step S202d is equal to 0 (step S202e). Note that the method of detecting the abnormality corresponding to the detection item 4 may be appropriately changed.

If it is determined that PS2 is equal to 0 (step S202e; Yes), the calculation unit 133 adds the item-specific abnormality value of the detection item 4 to the abnormality value (step S202f).

Specifically, for example, the calculation unit 133 determines that the detected abnormality corresponds to the detection item 4 in accordance with the setting information 131a and the determination result in step S202e. The calculation unit 133 specifies the item-specific abnormality value “1” associated with the detection item 4 in the setting information 131a. The calculation unit 133 adds the item-specific abnormality value “1” to the abnormality value.

If it is determined that PS2 is not 0 (step S202e; No) or step S202f is executed, the detection unit 132 returns to the communication control processing.

### (GIP Confirmation Process: Step S203)

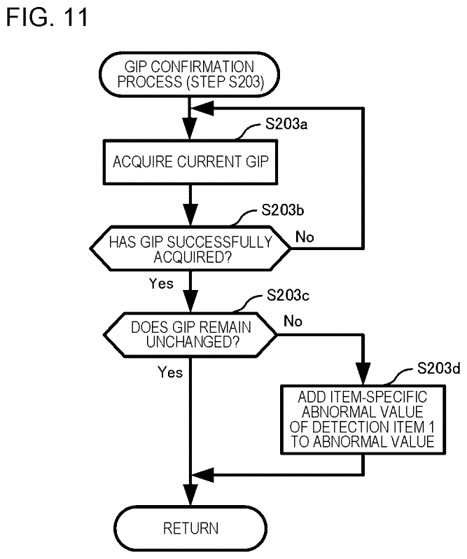

Subsequently, a GIP confirmation process (step S203) is executed. FIG. 11 is a flowchart illustrating an example of the GIP confirmation process (step S203) according to the example embodiment 1.

The detection unit 132 acquires the current GIP via the communication unit 122, for example (step S203a).

The detection unit 132 determines whether the current GIP has been successfully acquired in step S203a (step S203b). If the acquisition is not successful (step S203b; No), the detection unit 132 executes step S203a again. As a result, step S203a is repeatedly executed until the current GIP is successfully acquired.

Here, after acquiring the current GIP, the detection unit 132 may execute a process of the next step S203c after a predetermined standby time (for example, 1 second) elapses. Providing this standby time makes it possible to reduce an excessive processing load due to frequent and repeated execution of the abnormality detection processes DT.

If the acquisition is successful (step S203b; Yes), the detection unit 132 determines whether the GIP acquired in the first initial setting (step S101) is the same as the current GIP acquired in step S203a (step S203c). As a result, if the GIP of the information processing device 102 changes during the information processing, the change in the GIP can be detected. Note that this process is an example of a method of detecting an abnormality corresponding to the detection item 1, and may be appropriately changed.

If it is determined that the GIPs are not the same (step S203c; No), the calculation unit 133 adds the item-specific abnormality value of the detection item 1 to the abnormality value (step S203d).

Specifically, for example, the calculation unit 133 specifies that the detected abnormality corresponds to the detection item 1 in accordance with the setting information 131a and the determination result in step S203c. The calculation unit 133 specifies the item-specific abnormality value “4” associated with the detection item 1 in the setting information 131a. The calculation unit 133 adds the item-specific abnormality value “4” to the abnormality value.

If it is determined that the GIPs are the same (step S203c; Yes) or step S203d is executed, the detection unit 132 returns to the communication control processing.

### (Reception Confirmation Process: Step S204)

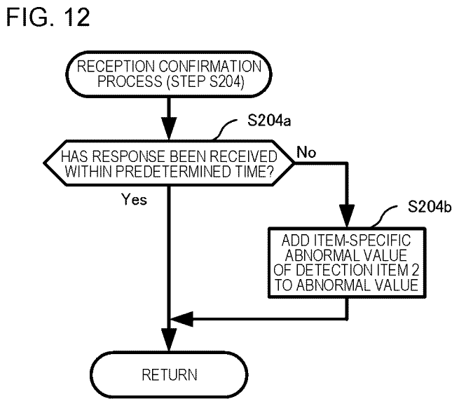

Subsequently, a reception confirmation process (step S204) is executed. FIG. 12 is a flowchart illustrating an example of the reception confirmation process (step S204) according to the first example embodiment.

In order to detect an abnormality corresponding to the detection item 2, the detection unit 132 determines, for example, whether the communication unit 122 has received a response from the server device 101 within a predetermined time (step S204a). The predetermined time here is a time preset for acquiring a response, and is, for example, 5 seconds. Note that this time length may be appropriately changed.

Note that the method of detecting the abnormality corresponding to the detection item 2 may be appropriately changed. For example, the detection unit 132 may determine whether the communication unit 122 has received reception information from the server device 101. Alternatively, for example, the detection unit 132 may transmit a predetermined request to the server device 101 via the communication unit 122, and the response may be used for the determination in step S204a.

If it is determined that a response has not been received (step S204a; No), the calculation unit 133 adds the item-specific abnormality value of the detection item 2 to the abnormality value (step S204b).

Specifically, for example, the calculation unit 133 determines that the detected abnormality corresponds to the detection item 2 in accordance with the setting information 131a and the determination result in step S204a. The calculation unit 133 specifies the item-specific abnormality value “2” associated with the detection item 2 in the setting information 131a. The calculation unit 133 adds the item-specific abnormality value “2” to the abnormality value.

If it is determined that a response has been received (step S204a; Yes) or step S204b is executed, the detection unit 132 returns to the communication control processing.

### (HD Confirmation Process: Step S205)

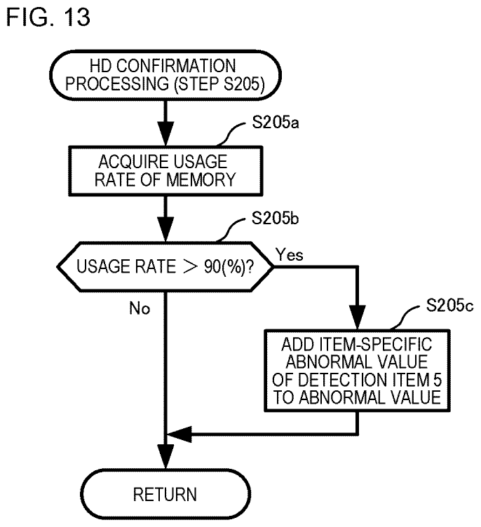

Subsequently, an HD confirmation process (step S205) is executed. FIG. 13 is a flowchart illustrating an example of the HD confirmation processing (step S205) according to the first example embodiment.

The detection unit 132 acquires a usage rate of a memory (for example, the memory 2030 illustrated in FIG. 6) in the information processing device 102 from the main processing unit 121, for example (step S205a).

In order to detect an abnormality corresponding to the detection item 5, the detection unit 132 determines, for example, whether the usage rate acquired in step S205a is greater than 90 (%) (step S205 b).

Note that the method of detecting the abnormality corresponding to the detection item 5 may be appropriately changed. Furthermore, “90 (%)” here is an example of a predetermined threshold value, and may be appropriately changed.

If it is determined that the usage rate is greater than 90 (%) (step S205b; Yes), the calculation unit 133 adds the item-specific abnormality value of the detection item 5 to the abnormality value (step S205c).

Specifically, for example, the calculation unit 133 determines that the detected abnormality corresponds to the detection item 5 in accordance with the setting information 131a and the determination result in step S205b. The calculation unit 133 specifies the item-specific abnormality value “1” associated with the detection item 5 in the setting information 131a. The calculation unit 133 adds the item-specific abnormality value “1” to the abnormality value.

If it is determined that the usage rate is not greater than 90 (%) (step S205b; No) or step S205c is executed, the detection unit 132 returns to the communication control processing.

Executing such an abnormality detection process DT causes the total of the item-specific abnormality values, which corresponds to the one or a plurality of detected abnormalities, to be held in the abnormality value. The abnormality value is a value associated with the possibility of causing a communication failure.

Reference is now made to FIG. 9.

The communication maintenance unit 134 determines whether the abnormality value is equal to or greater than the abnormality threshold value (step S206).

For example, it is assumed that the abnormality threshold value is 4. In this case, when an abnormality corresponding to the detection item 1 is detected, the abnormality value immediately becomes equal to or greater than the abnormality threshold value regardless of whether an abnormality corresponding to another detection item is detected. For the other detection items 2 to 5, when abnormalities corresponding to a plurality of detection items are detected, the abnormality value becomes equal to or greater than the abnormality threshold value.

As described above, each item-specific abnormality value is set to a scale associated with the possibility that the type of the detection item causes a communication failure. In this example, the detection item 1 is associated with an item-specific abnormality value associated with a high possibility of causing a communication failure. Note that each item-specific abnormality value may be appropriately set depending on whether restart is necessary for normalization, whether the main processing is processing that should wait for normalization of communication without restart, and the like.

Note that the abnormality threshold value is not limited to 4, and may be appropriately changed.

If it is determined that the abnormality value is equal to or greater than the abnormality threshold value (step S206; Yes), abnormality in communication has occurred or is highly likely to occur. Therefore, the communication maintenance unit 134 reconnects the communication between the server device 101 and the information processing device 102 (step S207).

For example, the communication maintenance unit 134 performs a process for reestablishing communication with the server device 101, on the communication unit 122. The process for reestablishing communication may include, for example, restarting the communication maintenance unit 134, and reacquiring GIP.

The reconnection of communication here is an example of the process for continuing communication. The process for continuing the communication is not limited thereto, and may be, for example, restarting of the information processing device 102, restarting of the information processing device 102 and the communication control device 103, or the like.

In step S207, the calculation unit 133 may set each of the abnormality value and the previous abnormality value to “0”, which is the initial value. As a result, the abnormality value and the previous abnormality value are initialized.

When a predetermined time (for example, 100 seconds) for waiting for completion of the process in step S207 elapses, the communication maintenance unit 134 causes the communication unit 122 to transmit the log data to the server device 101 (step S208).

For example, the communication maintenance unit 134 generates, for example, log data indicating that reconnection has been made. Then, the communication maintenance unit 134 causes the communication unit 122 to transmit the generated log data to the server device 101.

The log data may include one or more of a time when the reconnection is made, and a detection item corresponding to an abnormality detected when the reconnection is made.

If it is determined that the abnormality value is not the abnormality threshold value or more (step S206; No), the communication maintenance unit 134 determines whether the abnormality value is greater than the previous abnormality value (step S209).

If it is determined that the abnormality value is greater than the previous abnormality value (step S209; Yes), the calculation unit 133 sets the previous abnormality value to the abnormality value (step S210). As a result, the previous abnormality value is updated using the current abnormality value.

If it is determined that the abnormality value is not greater than the previous abnormality value (step S209; No), the calculation unit 133 sets each of the abnormality value and the previous abnormality value to “0”, which is an initial value (step S211). As a result, the abnormality value and the previous abnormality value are initialized.

When the abnormality value is greater than the previous abnormality value, and when an abnormality is detected in the next abnormality detection process DT, executing the processing of steps S209 to S211 causes the addition to be performed based on the current abnormality value. At the same time, the current abnormality value is used as the previous abnormality value in the next step S209.

Contrarily, when the abnormality value is not greater than the previous abnormality value, the abnormality value and the previous abnormality value are initialized before the next abnormality detection process DT is executed. The case in which the abnormality value is not greater than the previous abnormality value corresponds to a case in which an abnormality to an extent less than the abnormality threshold value is detected in the previous abnormality detection process DT and no abnormality is detected in the current abnormality detection process DT.

The communication maintenance unit 134 refers to the file storage unit 123, for example, and determines whether a terminate file is present (step S212). If the terminate file is not present (step S212; No), the processes from step S202 are executed again (see FIG. 8). If the terminate file is present (step S212; Yes), the communication maintenance unit 134 ends the communication control processing. Note that step S212 and the end of the communication control processing are not limited to being executed by the communication maintenance unit 134, and may be executed by the detection unit 132 or the calculation unit 133.

Executing such a communication control processing makes it possible to perform a process for continuing the communication when an abnormality in communication is detected.

### Operation and Effect

As described above, according to the present example embodiment, the communication control device 103 includes a detection unit 132, a calculation unit 133, and a communication maintenance unit 134. The detection unit 132 detects an abnormality in communication based on a plurality of detection items. The calculation unit 133 calculates an abnormality value when an abnormality is detected. The communication maintenance unit 134 performs a process for continuing the communication when the abnormality value exceeds a predetermined abnormality threshold value.

As a result, when the abnormality value exceeds the predetermined abnormality threshold value, a process for continuing communication can be performed. Therefore, communication can be autonomously sustained.

According to the present example embodiment, when an abnormality is detected, the calculation unit 133 uses the setting information 131a including values (item-specific threshold values) each associated with a corresponding one of the plurality of detection items, and thereby adds the value (item-specific threshold value), which is associated with a detection item in which the abnormality is detected, to the abnormality value.

As a result, when an abnormality occurs, the abnormality value can be calculated depending on the possibility that the abnormality causes a communication failure. This makes it possible to perform a process for continuing communication in an appropriate case while preventing execution of main processing from being delayed due to frequent execution of a process for continuing communication. Therefore, communication can be autonomously sustained.

According to the present example embodiment, a detection item of a predetermined type in the setting information 131a is associated with a greater value (item-specific threshold value) than detection items of other types

This makes it possible to associate a great item-specific threshold value with a detection item of a type that is highly likely to cause a communication failure when an abnormality occurs. This makes it possible to perform a process for continuing communication in an appropriate case while preventing execution of main processing from being delayed due to frequent execution of a process for continuing communication. Therefore, communication can be autonomously sustained.

According to the present example embodiment, the types of the detection items include at least one of an item related to connection of the communication, an item related to reception of information in the communication, an item related to transmission of information in the communication, an item related to main processing, an item related to hardware that executes the main processing, and an item related to a period to perform a process for continuing the communication.

As a result, an abnormality in communication can be detected using various detection items. This make it possible to perform a process for continuing the communication when an abnormality in communication is detected. Therefore, communication can be autonomously sustained.

According to the present example embodiment, the item related to communication connection includes an item related to a GIP address. The item related to the hardware that executes the main processing includes an item related to at least one of a usage amount of the memory, a usage rate of the memory, a temperature of the hardware, a processing load of the hardware, and a continuous operation time of the hardware. The item related to the period includes a period in which the vehicle stands by in the parking lot and no person is on the rear seat.

As a result, an abnormality in communication can be detected using various detection items. This make it possible to perform a process for continuing the communication when an abnormality in communication is detected. Therefore, communication can be autonomously sustained.

### First Modification

The first example embodiment may be modified as follows.

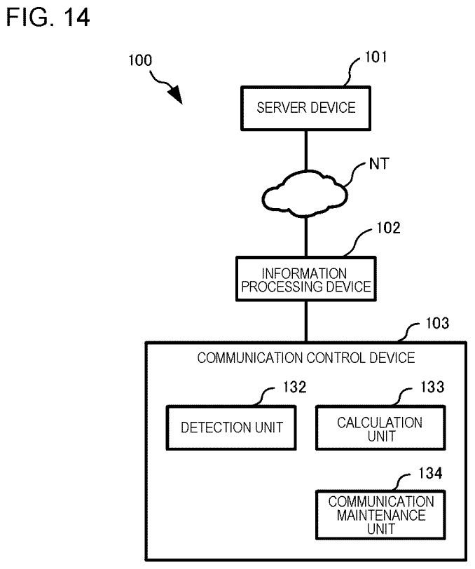

FIG. 14 is a diagram illustrating a configuration example of an information processing system 100 according to a first modification.

The information processing system 100 according to the present modification includes a server device 101, an information processing device 102, and a communication control device 103. The information processing device 102 communicates with the server device 101 to execute main processing. The communication control device 103 controls communication between the server device 101 and the information processing device 102. Note that FIG. 14 illustrates an example in which the communication control device 103 is provided outside the information processing device 102, but the communication control device 103 may be incorporated in the information processing device 102 as described in the first example embodiment.

The communication control device 103 includes a detection unit 132, a calculation unit 133, and a communication maintenance unit 134.

The detection unit 132 detects an abnormality in communication based on a plurality of detection items. The calculation unit 133 calculates an abnormality value when an abnormality is detected. The communication maintenance unit 134 performs a process for continuing the communication when the abnormality value exceeds a predetermined abnormality threshold value.

According to the information processing system 100, communication can be autonomously sustained.

### Second Example Embodiment

At least one of the plurality of item-specific abnormality values may be changed from a predetermined value as appropriate. In the present example embodiment, an example will be described in which a plurality of item-specific abnormality values is changed in response to a movement situation and an internal situation of an automobile. Also in the present example embodiment, an example will be described in which the information processing device 102 is mounted on an automobile, which is a moving body.

In the present example embodiment, in order to simplify the description, the description overlapping with the first example embodiment will be appropriately omitted.

### (Configuration Example of Information Processing System 200 According to Second Example Embodiment)

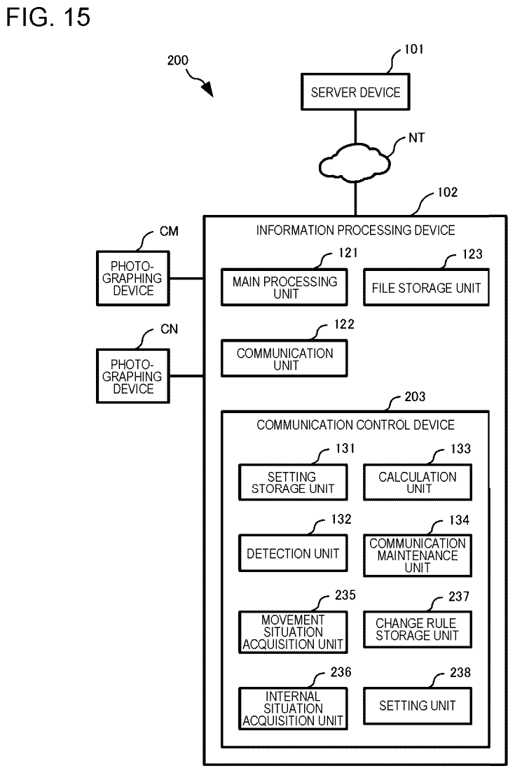

FIG. 15 is a diagram illustrating a configuration example of an information processing system 200 according to a second example embodiment. The information processing system 200 further includes a photographing device CN. The photographing device CN is an example of a sensor for the information processing device 102 to acquire information from the outside, and is, for example, a camera that photographs the inside of an automobile. Furthermore, the information processing system 200 includes a communication control device 203 instead of the communication control device 103 according to the first example embodiment.

Except for these, the information processing system 200 may be configured similarly to the information processing system 100 according to the first example embodiment.

### (Functional Configuration Example of Communication Control Device 203 According to Second Example Embodiment)

The communication control device 203 further functionally includes, a movement situation acquisition unit 235, an internal situation acquisition unit 236, a change rule storage unit 237, and a setting unit 238, for example. Except for these, the communication control device 203 may be configured similarly to the communication control device 103 according to the first example embodiment.

The movement situation acquisition unit 235 acquires the video captured by the photographing device CM, and acquires the movement situation based on the acquired video. The movement situation includes at least one of a situation related to movement of the automobile and a situation outside the automobile. For example, the movement situation acquisition unit 235 acquires the movement situation by analyzing the acquired video.

Note that the method by which the movement situation acquisition unit 235 acquires the movement situation is not limited thereto. The movement situation acquisition unit 235 may acquire the movement situation using, for example, information obtained from a control device of an automobile (not illustrated).

The internal situation acquisition unit 236 acquires the video captured by the photographing device CN, and acquires the internal situation based on the acquired video. The internal situation is a situation inside the automobile. For example, the internal situation acquisition unit 236 acquires the internal situation by analyzing the acquired video.

The change rule storage unit 237 stores change rule information that defines a rule for changing the setting information 131a. The change rule information includes, for example, one or more change rules that associate the change condition with the change method.

The change condition defines a condition for changing the setting information 131a. For example, the change condition includes a condition using at least one of the movement situation and the internal situation.

Specifically, for example, the change condition may include at least one of (A) that the automobile is moving, (B) that the automobile is stopped in a parking lot, and (C) that no person is on the rear seat of the automobile.

(A) and (B) are examples of conditions using the movement situation. (C) is an example of a condition using the internal situation.

Note that the change condition is not limited thereto. For example, the change condition may include a condition using both the movement situation and the internal situation. For example, the movement situation may be at least one of a moving speed, a moving place (for example, in the tunnel), and the like. The parking lot is an example of a stop place. The stop place may be, for example, a roadside.

The change method defines how to change at least one of the item-specific abnormality values included in the setting information 131a when the associated change condition is satisfied.

For example, when the change condition (A) that the automobile is moving is satisfied, it is highly likely that the communication is unstable. Therefore, the change method defines at least one of the item-specific abnormality values to be greater than when the automobile is stopped. Examples of the method of increasing the item-specific abnormality value include, but are not limited to, multiplying by a predetermined magnification (for example, 1.5), and adding a predetermined value (for example, 0.5).

For example, when a change condition is satisfied in (B) that the automobile is stopped in a parking lot or (C) that the rear seat of the automobile, reconnection of communication often has small influence on the safety of traffic. Therefore, the change method defines that at least one of the item-specific abnormality values is increased.

The setting unit 238 sets values (item-specific threshold values) included in the setting information 131a based on at least one of the movement situation and the internal situation.

Note that the communication control device 203 does not necessarily include any one of the movement situation acquisition unit 235 and the internal situation acquisition unit 236. In this case, the setting unit 238 may set the values (item-specific threshold values) included in the setting information 131a based on either the movement situation or the internal situation.

### (Hardware Configuration Example of Information Processing System 200 According to Second Example Embodiment)

Physically, an information processing system 200 may be configured in substantially the same manner as the information processing system 100 according to the first example embodiment.

### (Example of Change Processing According to Second Example Embodiment)

The information processing system 200 executes change processing in addition to information processing and communication control processing similar to those of the first example embodiment. An example of the change processing will be described with reference to the drawings.

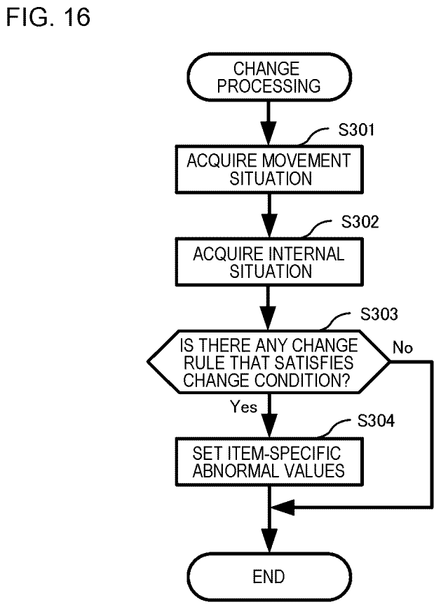

FIG. 16 is a flowchart illustrating an example of change processing according to the second example embodiment. The change processing is processing for changing the setting information 131a. The change processing may be executed repeatedly simultaneously in parallel with the communication control processing.

The movement situation acquisition unit 235 acquires the movement situation based on the video from the photographing device CM (step S301).

The internal situation acquisition unit 236 acquires the internal situation based on the video from the photographing device CN (step S302).

The setting unit 238 determines whether there is a change rule that satisfies a change condition among the change rules included in the change rule information, based on the movement situation and internal situation respectively acquired in steps S301 and S302 (step S303).

If there is no change rule that satisfies the change condition (step S303; Yes), the setting unit 238 ends the change processing.

If there is a change rule that satisfies the change condition (step S303; Yes), the setting unit 238 sets the item-specific threshold values included in the setting information 131a according to the change method (step S304), and ends the change processing.

Specifically, for example, the setting unit 238 specifies a change method associated with the change condition in the change rule that satisfies the change condition. The setting unit 238 changes the item-specific threshold values included in the setting information 131a using the specified change method, and sets the changed item-specific threshold values in the setting information 131a.

Executing such a change processing makes it possible to change the item-specific threshold values so as to autonomously sustain the communication in response to at least one of the movement situation and the internal situation.

### Operation and Effect

As described above, according to the present example embodiment, the communication control device 203 further includes the movement situation acquisition unit 235 and the setting unit 238. The movement situation acquisition unit 235 acquires the movement situation. The setting unit 238 sets values (item-specific threshold values) included in the setting information 131a based on the movement situation.

This makes it possible to change the item-specific threshold values so as to autonomously sustain the communication in response to the movement situation. Therefore, communication can be autonomously sustained.

According to the present example embodiment, the communication control device 203 further includes an internal situation acquisition unit 236 and a setting unit 238. The internal situation acquisition unit 236 acquires the internal situation of the moving body. The setting unit 238 sets values (item-specific threshold values) included in the setting information 131a based on the internal situation.

This makes it possible to change the item-specific threshold values so as to autonomously sustain the communication in response to the internal situation. Therefore, communication can be autonomously sustained.

### Second Modification

The change rule information according to the second example embodiment may define a rule for changing the abnormality threshold value. In this case, the change method may define how to change the abnormality threshold value when the associated change condition is satisfied. Also with this, executing the change processing similarly to the second example embodiment makes it possible to change the abnormality threshold value so as to autonomously sustain the communication in response to at least one of the movement situation and the internal situation. Therefore, communication can be autonomously sustained.

While the example embodiments of the present invention have been described above with reference to the drawings, these are examples of the present invention, and various configurations other than the above can be employed.

In the plurality of flowcharts used in the above description, a plurality of steps (processes) are described in order, but the execution order of the steps executed in each example embodiment is not limited to the described order. In each example embodiment, the order of the illustrated steps can be changed within a range in which there is no problem in contents. The above-described example embodiments can be combined within a range in which the contents are not contradictory.

Some or all of the above example embodiments may be described as the following supplementary notes, but are not limited to the following.
1. A communication control device including:
detection means for detecting an abnormality in communication based on a plurality of detection items;
calculation means for calculating an abnormality value when an abnormality is detected; and
communication maintenance means for performing a process for continuing the communication when the abnormality value exceeds a predetermined abnormality threshold value.
2. The communication control device according to 1., wherein
when the abnormality is detected, the calculation means uses setting information including values each associated with a corresponding one of the plurality of detection items, and thereby adds the value, which is associated with a detection item in which the abnormality is detected, to the abnormality value.
3. The communication control device according to 2., further including:
movement situation acquisition means for acquiring a movement situation; and
setting means for setting the values included in the setting information based on the movement situation.
4. The communication control device according to 2. or 3., further including:
internal situation acquisition means for acquiring an internal situation of a moving body; and
setting means for setting the values included in the setting information based on the internal situation.
5. The communication control device according to any one of 2. to 4., wherein
the detection item of a predetermined type in the setting information is associated with a value greater than a value of the detection item of another type.
6. The communication control device according to any one of claims 1. to 5., wherein
types of the detection items include at least one of: an item related to connection of the communication; an item related to reception of information in the communication; an item related to transmission of information in the communication; an item related to the main processing; an item related to hardware that executes the main processing, and an item related to a period for performing a process for continuing the communication.
7. The communication control device according to 6., wherein
the item related to connection of the communication includes an item related to a GIP address,
the item related to hardware that executes the main processing includes an item related to at least one of a usage amount of a memory, a usage rate of a memory, a temperature of the hardware, a processing load of the hardware, and a continuous operation time of the hardware, and
the item related to a period includes a period in which a vehicle stands by in a parking lot and no person is on a rear seat.
8. An information processing system including:
a server device;
an information processing device that communicates with the server device and executes main processing; and
a communication control device that controls communication between the server device and the information processing device,
wherein the communication control device includes:
detection means for detecting an abnormality in communication based on a plurality of detection items;
calculation means for calculating an abnormality value when an abnormality is detected; and
communication maintenance means for performing a process for continuing the communication when the abnormality value exceeds a predetermined abnormality threshold value.
9. An information processing system including:
a server device; and
the communication control device according to any one of 1. to 7.
10. A communication control processing method, including
causing one or more computers to:
detect an abnormality in communication based on a plurality of detection items;
calculate an abnormality value when an abnormality is detected; and
perform a process for continuing the communication when the abnormality value exceeds a predetermined abnormality threshold value.
11. The communication control processing method according to 10., wherein
when the abnormality is detected, detection of the abnormality uses setting information including values each associated with a corresponding one of the plurality of detection items, and thereby adds the value, which is associated with a detection item in which the abnormality is detected, to the abnormality value.
12. The communication control processing method according to 11., further including:
acquiring a movement situation; and
setting the values included in the setting information based on the acquired movement situation.
13. The communication control processing method according to 11. or 12., further including:
acquiring an internal situation of a moving body; and
setting the values included in the setting information based on the acquired internal situation.
14. The communication control processing method according to any one of 11.to 13., wherein
the detection item of a predetermined type in the setting information is associated with a value greater than a value of the detection item of another type.
15. The communication control processing method according to any one of 10.to 14., wherein
types of the detection items include at least one of: an item related to connection of the communication; an item related to reception of information in the communication; an item related to transmission of information in the communication; an item related to the main processing; an item related to hardware that executes the main processing, and an item related to a period for performing a process for continuing the communication.
16. The communication control processing method according to 15., wherein
the item related to connection of the communication includes an item related to a GIP address,
the item related to hardware that executes the main processing includes an item related to at least one of a usage amount of a memory, a usage rate of a memory, a temperature of the hardware, a processing load of the hardware, and a continuous operation time of the hardware, and
the item related to a period includes a period in which a vehicle stands by in a parking lot and no person is on a rear seat.
17. A program including causing one or more computers to execute:
detect an abnormality in communication based on a plurality of detection items;
calculate an abnormality value when an abnormality is detected; and
perform a process for continuing the communication when the abnormality value exceeds a predetermined abnormality threshold value.
18. The program according to 17., wherein
when the abnormality is detected, detection of the abnormality uses setting information including values each associated with a corresponding one of the plurality of detection items, and thereby adds the value, which is associated with a detection item in which the abnormality is detected, to the abnormality value.
19. The program according to 18., further including causing one or more computers to execute:
acquiring a movement situation; and
setting the values included in the setting information based on the acquired movement situation.
20. The program according to 18. or 19., further including causing one or more computers to further execute:
acquiring an internal situation of a moving body; and
setting the values included in the setting information based on the internal situation.
21. The program according to any one of 18. to 20., wherein
the detection item of a predetermined type in the setting information is associated with a value greater than a value of the detection item of another type.
22. The program according to any one of 17. to 21., wherein
types of the detection items include at least one of: an item related to connection of the communication; an item related to reception of information in the communication; an item related to transmission of information in the communication; an item related to the main processing; an item related to hardware that executes the main processing, and an item related to a period for performing a process for continuing the communication.
23. The program according to 22., wherein
the item related to connection of the communication includes an item related to a GIP address,
the item related to hardware that executes the main processing includes an item related to at least one of a usage amount of a memory, a usage rate of a memory, a temperature of the hardware, a processing load of the hardware, and a continuous operation time of the hardware, and
the item related to a period includes a period in which a vehicle stands by in a parking lot and no person is on a rear seat.
24. A recording medium including a program recorded thereon, the program being configured to cause one or more computers to execute:
detecting an abnormality in communication based on a plurality of detection items;
calculating an abnormality value when an abnormality is detected; and
performing a process for continuing the communication when the abnormality value exceeds a predetermined abnormality threshold value.
25. A recording medium including a program according to any one of 17. to 23., recorded thereon.

### REFERENCE SIGNS LIST

100,200 information processing system
101 server device
102 information processing device
103, 203 communication control device
121 main processing unit
122 communication unit
123 file storage unit
131 setting storage unit
131a setting information
132 detection unit
133 calculation unit
134 communication maintenance unit
235 movement situation acquisition unit
236 Internal situation acquisition unit
237 change rule storage unit
238 setting unit

What is claimed is:

1. A communication control apparatus comprising:
a memory configured to store instructions; and
a processor configured to execute the instructions to:
detect an abnormality in communication based on a plurality of detection items;
calculate an abnormality value when an abnormality is detected; and
perform a process for continuing the communication when the abnormality value exceeds a predetermined abnormality threshold value.

2. The communication control apparatus according to claim 1, wherein
when the abnormality is detected, calculating the abnormality value uses setting information including values each associated with a corresponding one of the plurality of detection items, and thereby adds the value, which is associated with a detection item in which the abnormality is detected, to the abnormality value.

3. The communication control apparatus according to claim 2, wherein the processor configured to further execute the instructions to:
acquire a movement situation; and
set the values included in the setting information based on the movement situation.

4. The communication control apparatus according to claim 2, wherein the processor configured to further execute the instructions to:
acquire an internal situation of a moving body; and
set the values included in the setting information based on the internal situation.

5. The communication control apparatus according to claim 2, wherein
the detection item of a predetermined type in the setting information is associated with a value greater than a value of the detection item of another type.

6. The communication control apparatus according to claim 1, wherein
types of the detection items include at least one of: an item related to connection of the communication; an item related to reception of information in the communication; an item related to transmission of information in the communication; an item related to a main processing; an item related to hardware that executes the main processing, and an item related to a period for performing a process for continuing the communication.

7. The communication control apparatus according to claim 6, wherein
the item related to connection of the communication includes an item related to a GIP address,
the item related to hardware that executes the main processing includes an item related to at least one of a usage amount of a memory, a usage rate of a memory, a temperature of the hardware, a processing load of the hardware, and a continuous operation time of the hardware, and
the item related to a period includes a period in which a vehicle stands by in a parking lot and no person is on a rear seat.

8. (canceled)

9. A communication control processing method, comprising
causing one or more computers to:
detect an abnormality in communication based on a plurality of detection items;
calculate an abnormality value when an abnormality is detected; and
perform a process for continuing the communication when the abnormality value exceeds a predetermined abnormality threshold value.

10. A non-transitory computer readable medium comprising a program recorded thereon, the program being configured to cause one or more computers to execute:
detecting an abnormality in communication based on a plurality of detection items;
calculating an abnormality value when an abnormality is detected; and
performing a process for continuing the communication when the abnormality value exceeds a predetermined abnormality threshold value.
